(19) United States
(12) Patent Application Publication
(10) Pub. No.: US 2011/0154133 A1
(43) Pub. Date: Jun. 23, 2011

(54) TECHNIQUES FOR ENHANCING FIRMWARE-ASSISTED SYSTEM DUMP IN A VIRTUALIZED COMPUTER SYSTEM EMPLOYING ACTIVE MEMORY SHARING

(75) Inventors: Veena Ganti, Austin, TX (US); David Nevarez, Austin, TX (US); Jacob J. Rosales, Austin, TX (US); Morgan J. Rosas, Cedar Park, TX (US)

(73) Assignee: International Business Machines Corporation, Armonk, NY (US)

(21) Appl. No.: 12/644,332

(22) Filed: Dec. 22, 2009

(51) Int. Cl. G06F 11/14; G06F 9/455; G06F 15/177

(52) U.S. Cl. 714/54; 718/1; 713/2; 714/E11.133

(57) ABSTRACT

A technique for performing a system dump in a data processing system that implements active memory sharing includes assigning, via a hypervisor, a logical partition to a portion of a shared memory. One or more virtual block storage devices are also assigned by the hypervisor to the logical partition to facilitate active memory sharing of the shared memory. When a hypervisor-aided firmware-assisted system dump is indicated and a failure of the logical partition is detected, firmware initiates a system dump of information from the assigned portion of the shared memory to the one or more virtual block storage devices. An operating system of the logical partition is rebooted when enough of the assigned portion of the shared memory is freed to facilitate a reboot of the operating system and the hypervisor-aided firmware-assisted system dump is indicated.

### BACKGROUND

This disclosure relates generally to a virtualized computer system and, more specifically, to techniques for enhancing firmware-assisted system dump in a virtualized computer system employing active memory sharing.

In a virtualized computer system, an operating system (OS) may be configured to execute inside a logical partition (LPAR) or virtual client that is configured to provide access to various system resources (e.g., processors, memory, and input/output (I/O)). In general, a given system resource can be dedicated to an individual LPAR or shared among one or more LPARs, each of which executes a different OS (which may be the same type of OS or a different type of OS, e.g., Linux, AIX). Resource sharing allows multiple LPARs to access the same resource (e.g., under the control of a hypervisor (virtual machine monitor) that monitors load, applies allocation rules, and time shares access to the resource). From the standpoint of a given LPAR, a shared resource is treated as though the given LPAR has exclusive access to the shared resource. In a typical virtualized computer system, a hypervisor manages access to a shared resource to avoid conflicts while providing access to LPARs with higher resource requirements. For example, in a virtualized computer system, an LPAR may be assigned one or more logical processors from a pool of physical processors based on pool access rules. In this case, a hypervisor may be configured to assign physical processors to logical processors for a period of time that depends on pool access rules and the load of all LPARs. In general, the assignment of physical processors to logical processors is transparent to an OS, which assigns threads to logical processors as though the logical processors are physical processors.

In addition to traditional dedicated memory assignments to individual LPARs, a physical memory pool may be created that is shared among a set of LPARs using, for example, active memory sharing (AMS). AMS is a virtualization technology that allows multiple LPARs to share a pool of physical memory. In this case, physical memory is allocated by a hypervisor (from a shared memory pool) based on LPAR runtime memory requirements. In general, AMS facilitates over-commitment of memory resources. That is, since logical memory is mapped to physical memory based on memory demand, the sum of all LPAR logical memory can exceed a shared memory pool size. When the cumulative usage of physical memory reaches a shared memory pool size, a hypervisor can transparently reassign memory from one LPAR to another LPAR. When a memory page that is to be reassigned contains information, the information is stored on a paging device and the memory page is usually cleared before the memory page is assigned to another LPAR. If a newly assigned memory page previously contained information for an LPAR, the information is restored from a paging device. Since paging activity has a cost in terms of logical memory access time, a hypervisor typically tracks memory usage such that memory that will not be used in the near future is reassigned. In general, an OS cooperates with a hypervisor by providing hints about memory page usage and freeing memory pages to limit hypervisor paging.

### SUMMARY

According to one aspect of the present disclosure, a technique for performing a system dump in a data processing system that implements active memory sharing includes assigning, via a hypervisor, a logical partition to a portion of a shared memory. One or more virtual block storage devices are also assigned (by the hypervisor) to the logical partition to facilitate active memory sharing. When a failure of the logical partition is detected and a hypervisor-aided firmware-assisted system dump is indicated, firmware initiates a system dump of information from the assigned portion of the shared memory to the one or more virtual block storage devices. An operating system of the logical partition is rebooted when enough of the assigned portion of the shared memory is freed to facilitate a reboot of the operating system and the hypervisor-aided firmware-assisted system dump is indicated.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of a virtual environment where active memory sharing (AMS) is utilized to over-commit memory to a logical partition (LPAR) or virtual client.

FIG. 2 is a diagram of an example computer system that may implement a virtual environment according to FIG. 1.

FIG. 3 is a flowchart of an example process for enhancing firmware-assisted system dump, according to an embodiment of the present disclosure.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. As may be used herein, the term “coupled” includes both a direct electrical connection between blocks or components and an indirect electrical connection between blocks or components achieved using one or more intervening blocks or components.

According to various aspects of the present disclosure, a virtualized computer system is configured to generate a system dump when a severe error occurs in a logical partition (LPAR). The system dump creates a snap-shot of a system memory that may be utilized to, for example, debug new applications. In a traditional system dump, when a severe error occurs, an operating system (OS) performs a complete system dump and then reboots. That is, in a traditional system dump, when an OS detects an internal problem severe enough to require a reboot of the OS, the OS attempts to save critical information (e.g., memory and registers) to an input/output (I/O) device (e.g., tape, direct access storage device (DASD), compact disc (CD), etc.) to facilitate debugging the problem at a later point in time. In a traditional system dump, the OS attempts to save critical information at the time the error is detected and before the OS is rebooted. One flaw with the traditional system dump is that a detected internal error may adversely affect the ability of an OS to perform a valid system dump.

In contrast, in a firmware-assisted system dump, firmware performs at least a portion of the system dump prior to an OS of an LPAR being rebooted. That is, when an OS detects a need for a system dump, instead of processing information in an error mode, the OS requests a system dump reboot. When firmware receives the system dump reboot request, information that would be overwritten by a reboot of an OS of an LPAR is copied (by the firmware) to a reserved area of LPAR memory. When an adequate amount of memory is available for the OS of the LPAR to be rebooted, the firmware transfers control to the OS. Following rebooting of the OS of the LPAR, the OS then writes the system dump information (i.e., the system dump information from the reserved area in LPAR memory and any other remaining system dump information not in the reserved area of the LPAR memory) to an I/O device (e.g., tape, DASD, CD, etc.).

According to various aspects of the present disclosure, when a virtualized computer system is employing active memory sharing (AMS), firmware-assisted system dump leverages AMS resources. In general, AMS allows virtual block storage devices (VBSDs) associated with a virtual input/output server (VIOS) to be used as paging space for a system where memory has been over committed. According to various aspects of the present disclosure, a VBSD driver (within an AMS stack) that is utilized to export storage that is to be used by a hypervisor for paging space may be utilized by the hypervisor to provide a paging space device for firmware-assisted system dump.

According to one aspect of the present disclosure, hypervisor paging logic is extended to handle firmware-assisted system dump using a paging device supplied by the VIOS. In this case, a hypervisor may partition a VBSD paging device to allow portions of the device to be used explicitly for system dumps. In one or more embodiments, reserved capacity may be set equal to a capacity of physical memory allocated for an AMS LPAR. Following configuration of the paging device, firmware may then write to the paging device when a system dump is indicated.

Employing a hypervisor-aided firmware-assisted system dump advantageously: decouples a failing OS from the system dump process; allows for faster recovery for a failing OS; and removes the need for reserved physical memory employed in traditional (conventional) firmware-assisted system dump. As a hypervisor has access to VSBDs via AMS, the hypervisor-aided firmware-assisted system dump uses AMS paging devices to store dump information when an OS experiences an unrecoverable error. It should be appreciated that in many cases some of the running memory for an OS of an LPAR is already stored on an AMS paging device. As such, when an OS goes down, only the portion of physical memory that is not already stored on the AMS paging device is dumped out to the AMS paging device following detection of an unrecoverable error.

It should also be appreciated that once the system dump data is on the AMS paging device, the data is persistent. In general, this frees up physical memory to be used for the reboot of the OS in a more timely fashion. When the OS reboots, the OS can then copy the system dump image from the AMS paging device to any storage device, as desired. Alternatively, an OS may choose to leave the system dump on the AMS paging device, since the AMS paging device is persistent storage. In general, LPAR recovery time is improved since a portion of running memory is already on disk and only the physical memory needs to be saved to the AMS paging device.

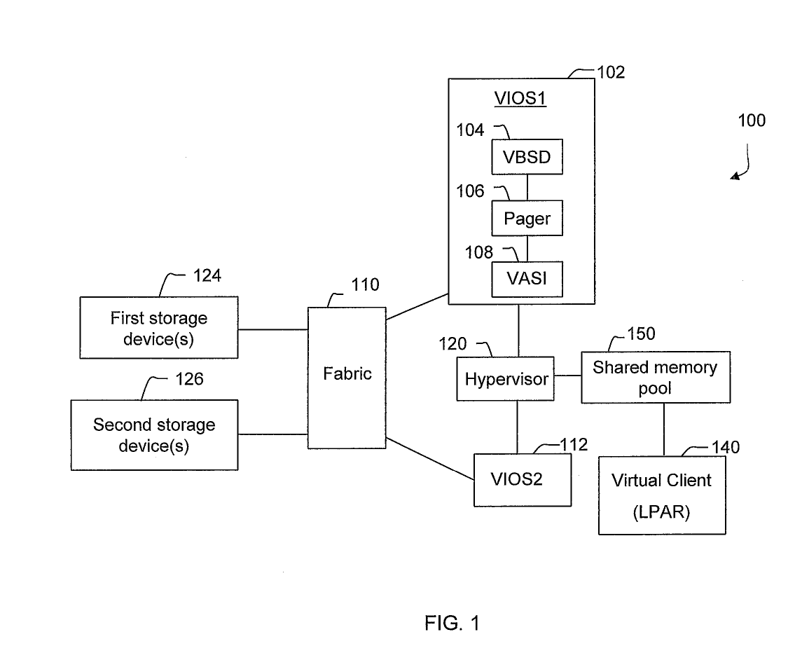

With reference to FIG. 1, a virtualized environment 100 that employs active memory sharing (AMS) to over-commit memory to a virtual client or logical partition (LPAR) 140 is illustrated. As is shown, a first virtual I/O server (VIOS) 102 and a second VIOS 112 are in communication with a hypervisor 120 and a fabric 110. The hypervisor 120 is configured to allocate memory (from shared memory pool 150) to the LPAR 140. The VIOS (labeled ‘VIOS1’) 102 is also in communication with one or more first storage devices 124 (which may be disks that are exported to the LPAR 140) and the VIOS (labeled ‘VIOS2’) 112 is also in communication with one or more second storage devices 126 (which may be disks that are exported to the hypervisor 120 for use as paging space to over commit memory to multiple LPARs) via the fabric 110. Each of the VIOSs 102 and 112 include a virtual block storage device (VBSD) driver 104 (used to communicate with VBSDs), a pager 106 (used to page memory from the shared memory pool 150 to a VBSD), and a virtual asynchronous services interface (VASI) 108 (used to communicate with the hypervisor 120). It should be appreciated that disks exported as paging space look like actual physical memory to the LPARs. For example, if the LPAR 140 only has 1 G of physical memory, but the memory was over committed with 2 G of disk storage, the LPAR 140 will see 3 G of physical memory. In general, the paging space is transparent to the LPARs.

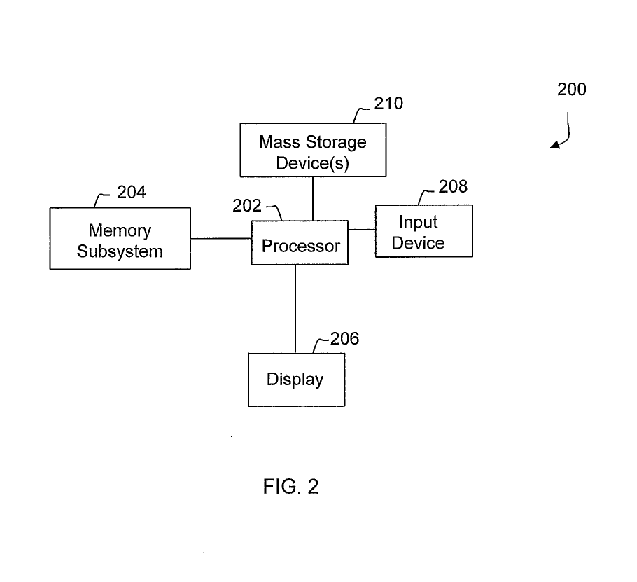

With reference to FIG. 2, an example computer system 200 is illustrated that may be configured to implement the virtual environment 100 of FIG. 1, according to various embodiments of the present disclosure. The computer system 200 includes a processor 202 that is coupled to a memory subsystem 204, a display 206, an input device 208, and mass storage device(s) 210. The memory subsystem 204 includes an application appropriate amount of volatile memory (e.g., dynamic random access memory (DRAM)) and non-volatile memory (e.g., read-only memory (ROM)). The display 206 may be, for example, a cathode ray tube (CRT) or a liquid crystal display (LCD). The input device 208 may include, for example, a mouse and a keyboard. The mass storage device(s) 210 (which may include, for example, a compact disc read-only memory (CD-ROM) drive and/or a hard disk drive (HDD)) are configured to receive or include discs that store appropriate code and may, for example, provide paging space.

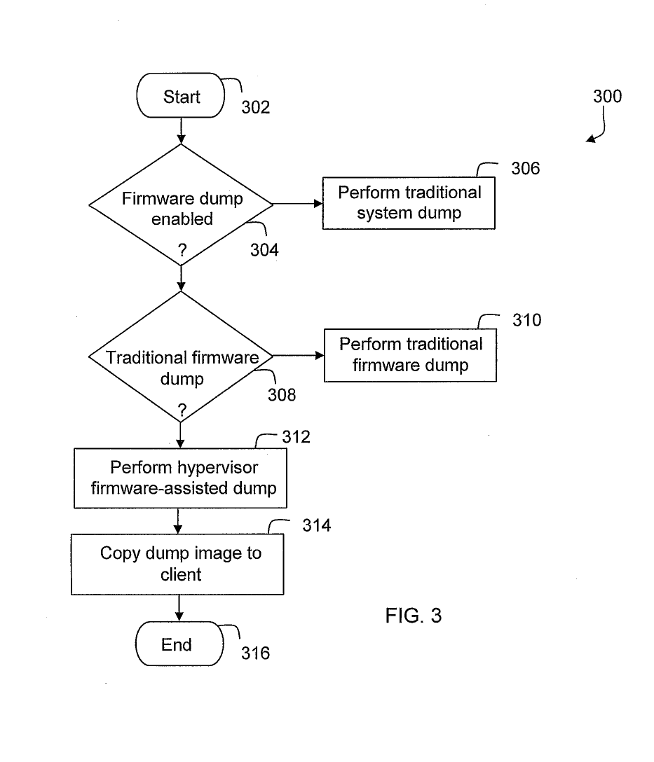

With reference to FIG. 3, a process 300 depicts one example of how a hypervisor-aided firmware-assisted system dump may be configured. The process 300 is initiated in block 302 when an LPAR error is detected. Next, in decision block 304, the process 300 determines whether a firmware-assisted system dump is enabled. If a firmware-assisted system dump is not enabled in block 304, control transfers to block 306 where a traditional system dump is initiated. If a firmware-assisted system dump is enabled in block 304, control transfers to decision block 308 where the process 300 determines whether a traditional firmware-assisted system dump is indicated. If a traditional firmware-assisted system dump is indicated in block 308, control transfers to block 310 where a traditional firmware-assisted system dump is initiated.

If a traditional firmware-assisted system dump is not indicated in block 308, control transfers to block 312 where a hypervisor-aided firmware-assisted system dump is initiated. In this case, the firmware initiates writing system dump information to VBSD paging space and transfers control to the OS (for OS reboot) when an adequate amount of memory is available for the OS reboot. The OS, following reboot completes the system dump to the VBSD paging space. Following block 312, control transfers to block 314 where the dump image is copied to another location. Alternatively, as the system dump is already on persistent storage, block 314 may be omitted. Following block 314, control transfers to block 316 where the process 300 terminates.

As one example, an LPAR could have 5 GB of assigned physical memory, while 10 GB of total physical memory is implemented in a virtualized computer system. Using AMS the LPAR could have, for example, 10 GB of additional AMS paging space. In this case, according to the present disclosure, an additional 5 GB of paging space is reserved to handle a system dump. As such, the total AMS paging space allocated is 15 GB (10 GB seen by the LPAR and 5 GB reserved). In this case, the AMS LPAR OS sees 15 GB of available memory even though there is only 10 GB of physical memory in the virtualized computer system. In a traditional firmware-assisted system dump scenario only 10 GB of the AMS client partition memory could be saved. This leaves 5 GB of memory that would not be included in the system dump. However, using a hypervisor-aided firmware-assisted system dump as described herein allows the entire 15 GB of memory to be saved in the hypervisor assigned paging device. In this manner, all system dump information is available to use for problem determination.

Accordingly, a number of techniques have been disclosed herein that generally enhance firmware-assisted system dump in a virtualized computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for performing a system dump in a data processing system that implements active memory sharing, comprising:
assigning, via a hypervisor, a logical partition to a portion of a shared memory;
assigning, via the hypervisor, one or more virtual block storage devices to the logical partition to facilitate active memory sharing of the shared memory;
detecting a failure of the logical partition;
initiating, using firmware, a system dump of information from the assigned portion of the shared memory to the one or more virtual block storage devices responsive to the failure of the logical partition when a hypervisor-aided firmware-assisted system dump is indicated; and
rebooting an operating system of the logical partition when enough of the assigned portion of the shared memory is freed to facilitate a reboot of the operating system and when the hypervisor-aided firmware-assisted system dump is indicated.

2. The method of claim 1, wherein the one or more virtual block storage devices correspond to one or more respective active memory sharing paging devices.

3. The method of claim 2, wherein the one or more respective active memory sharing paging devices include at least some of the information associated with the logical partition prior to the detecting a failure.

4. The method of claim 1, wherein the operating system executes within the logical partition.

5. The method of claim 1, wherein the failure of the logical partition corresponds to an unrecoverable error associated with the operating system.

6. The method of claim 1, further comprising:
performing a traditional firmware-assisted system dump, when the traditional firmware-assisted system dump is indicated.

7. The method of claim 1, further comprising:
performing a traditional system dump, when the traditional system dump is indicated.

8. The method of claim 1, further comprising:
completing, using the operating system, the system dump of the information from the assigned portion of the shared memory to the one or more virtual block storage devices following rebooting of the operating system.

9. A data processing system that implements active memory sharing, comprising:
a memory subsystem; and
one or more processors coupled to the memory subsystem, wherein the one or more processors are configured to:
assign, via a hypervisor, a logical partition to a portion of a shared memory;
assign, via the hypervisor, one or more virtual block storage devices to the logical partition to facilitate active memory sharing of the shared memory;
detect a failure of the logical partition;
initiate, using firmware, a system dump of information from the assigned portion of the shared memory to the one or more virtual block storage devices responsive to the failure of the logical partition when a hypervisor-aided firmware-assisted system dump is indicated; and
reboot an operating system of the logical partition when enough of the assigned portion of the shared memory is freed to facilitate a reboot of the operating system and when the hypervisor-aided firmware-assisted system dump is indicated.

10. The data processing system of claim 9, wherein the one or more virtual block storage devices correspond to one or more respective active memory sharing paging devices.

11. The data processing system of claim 10, wherein the one or more respective active memory sharing paging devices include at least some of the information associated with the logical partition prior to the detecting a failure.

12. The data processing system of claim 9, wherein the operating system executes within the logical partition.

13. The data processing system of claim 9, wherein the failure of the logical partition corresponds to an unrecoverable error associated with the operating system.

14. The data processing system of claim 9, wherein the one or more processors are further configured to:
perform a traditional firmware-assisted system dump, when the traditional firmware-assisted system dump is indicated; and
perform a traditional system dump, when the traditional system dump is indicated.

15. The data processing system of claim 9, wherein the one or more processors are further configured to:
complete, using the operating system, the system dump of the information from the assigned portion of the shared memory to the one or more virtual block storage devices following rebooting of the operating system.

16. A computer program product for performing a system dump in a data processing system that implements active memory sharing, the computer program product comprising:
a computer readable storage medium having computer readable program code embodied therewith, the computer readable program code comprising computer readable program code configured to:
assign, via a hypervisor, a logical partition to a portion of a shared memory;
assign, via the hypervisor, one or more virtual block storage devices to the logical partition to facilitate active memory sharing of the shared memory;
detect a failure of the logical partition;
initiate, using firmware, a system dump of information from the assigned portion of the shared memory to the one or more virtual block storage devices responsive to the failure of the logical partition when a hypervisor-aided firmware-assisted system dump is indicated; and
reboot an operating system of the logical partition when enough of the assigned portion of the shared memory is freed to facilitate a reboot of the operating system and when the hypervisor-aided firmware-assisted system dump is indicated.

17. The computer program product of claim 16, wherein the one or more virtual block storage devices correspond to one or more respective active memory sharing paging devices, and wherein the one or more respective active memory sharing paging devices include at least some of the information associated with the logical partition prior to the detecting a failure.

18. The computer program product of claim 16, wherein the operating system executes within the logical partition.

19. The computer program product of claim 16, wherein the failure of the logical partition corresponds to an unrecoverable error associated with the operating system.

20. The computer program product of claim 16, the code further comprising code that, when executed, causes the data processing system to:
complete, using the operating system, the system dump of the information from the assigned portion of the shared memory to the one or more virtual block storage devices following rebooting of the operating system.
